(19) United States
(12) Patent Application Publication
(10) Pub. No.: US 2008/0307220 A1
(43) Pub. Date: Dec. 11, 2008

(54) VIRTUAL CLOSED-CIRCUIT COMMUNICATIONS

(76) Inventor: Tom Campbell, Bellevue, WA (US)

Correspondence Address: STRATEGIC PATENTS P.C.., C/O PORTFOLIOIP, P.O. BOX 52050, MINNEAPOLIS, MN, 55402, US

(21) Appl. No.: 12/115,505

(22) Filed: May 5, 2008

Related U.S. Application Data
(60) Provisional application No. 60/915,835, filed on May 3, 2007.

(51) Int. Cl. H04L 9/32

(52) U.S. Cl. 713/155

(57) ABSTRACT

A virtual closed circuit supports transactions between businesses and consumers. More generally, techniques are disclosed for supporting a secure, non-public, business-to-consumer communication link suitable for use with financial transactions and other data communications related thereto. The communication link may be deployed in a desktop widget or other application to integrate communications and interactions with various authenticated online businesses.

### RELATED APPLICATIONS

This application claims the benefit of U.S. application Ser. No. 60/915,835 filed on May 3, 2007, the entire content of which is incorporated herein by reference.

### BACKGROUND

1. Field

The invention relates to electronic commerce, and more particularly to virtual closed-circuit communications systems and methods.

2. Description of the Related Art

Web communications such as electronic mail and instant messaging provide a convenient mechanism for people to interact and conduct transactions. While each of these mediums provides certain advantages, there remains a need for a business-to-consumer communications platform that permits secure, closed-circuit communications between transacting parties for use in payments, technical support, customer service, and the like.

### SUMMARY

A virtual closed circuit supports transactions between businesses and consumers. More generally, techniques are disclosed for supporting a secure, non-public, business-to-consumer communication link suitable for use with financial transactions and other data communications related thereto. The communication link may be deployed in a desktop widget or other application to integrate communications and interactions with various authenticated online businesses.

In one aspect, a system disclosed herein includes a client interface supporting secure communications with a client; an application server supporting secure communications with a third-party service; and a gateway adapted to receive an authorization from the client for inbound messages from the third-party service, to provide real time notification to the client of an inbound message from the third-party service, and to create a substantially real time, secure, bi-directional communication link between the client and the third-party service upon acceptance of the inbound message by the client.
The client may be a desktop widget. The third-party service may be one or more of a customer care service, a technical support service, or an advertisement service. The bi-directional communication link may include instant messaging. The gateway may be further adapted to receive a message from the client and to responsively establish a client-initiated communication link, the client-initiated communication link including a substantially real time, secure, bi-directional communication link between the client and the third-party service. The client may initiate a purchase transaction through the client-initiated link. The third-party service may make at least one recommendation for the purchase based on a profile associated with the client.
In another aspect, a system disclosed herein includes a client interface supporting secure communications with a client; an application server supporting secure communications with a third-party service; and a gateway adapted to automatically authenticate the client to the third-party service, and to establish a communications link between the client and the third-party service for conducting a transaction including payment by an online financial service, the link being a bi-directional, substantially real time, secure communications link.
The client may include a desktop widget. The transaction may include a purchase of a digital content item. The digital content item may be delivered to a user through the client. Payment for the digital content item may be provided through the online financial service.
In another aspect, a system disclosed herein includes a client interface supporting secure communications with a client; an application server supporting a first secure interface with an online auction system and a second secure interface with an online financial system; and a gateway adapted to store first login credentials from the client for the online auction system and establish a secure link to the online auction system through the application server using the first login credentials, and to store second login credentials from the client for the online financial system and establish a secure link to the online financial system using the second login credentials, wherein the gateway transmits a status of an auction of an item in the online auction system to the client and wherein the gateway supports secure bidding for and purchase of the item from the client.
The client may include a desktop widget. The gateway may be adapted to store the first login credentials or the second login credentials at a remote location. The gateway may be adapted to store the first login credentials or the second login credentials in encrypted form. The gateway may be further adapted to store third login credentials from the client for an automated bidding system and establish a secure link to the automated bidding system using the third login credentials. The gateway may transmit a real time status of the auction to the client, the real time status continually updated at the client. The gateway may be adapted to receive a client authorization to receive unsolicited alerts from the online auction system. The online financial system may include a credit card system or a PayPal system.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 depicts an email alert box and associated menu bar icon.

FIG. 2 depicts a web-based email client user interface.

FIG. 3 depicts a main window of an instant messaging client.

FIG. 4 depicts a chat window of an instant messaging client.

FIG. 5 depicts an advertisement for an instant messenger.

FIG. 6 depicts a virtual closed-circuit communications widget.

FIG. 7 depicts a login screen on a widget.

FIG. 8 depicts a busy indicator on a widget.

FIG. 9 depicts a confirmation screen on a widget.

FIG. 10 depicts a minimized widget.

FIG. 11 depicts a maximized widget.

FIG. 12 depicts a user's interaction with a widget.

FIG. 13 depicts a message history web page.

FIG. 14 depicts a closed-circuit communications system.

### DETAILED DESCRIPTION

In embodiments, the present invention provides a virtual closed-circuit communications capability that allows a plurality of businesses to communicate with customers. From the customers' perspective, the communications may be provided via a widget, which may be a dashboard widget, web-based widget, desktop widget, telephone widget, or any and all other kinds of widget. The communications capability may be directed at transactions, technical support, customer service interactions, and the like. The communications capability may, in some respects, share aspects of instant messaging, electronic mail, web browsing, and the like. The communications may be secured by a cryptographic protocol such as and without limitation SSL, SSH, and so on. The communications capability may provide authenticated, verified, and/or secure communications. The communications capability may be associated with a single-user sign on capability that allows a customer to communicate and transact business with a plurality of businesses without requiring a separate user name, password, registration, or the like with each of the businesses. The communications capability may be associated with or comprise storing and retrieving sensitive information, such as and without limitation user names, passwords, credit card numbers, bank account numbers, social security numbers, and the like in a secure fashion. For example and without limitation, in embodiments a customer may order a pizza using the communications capability and a payment for the pizza may be processed by or in association with the communications capability, which may securely retrieve and utilize his credit card information, all without the customer providing his credit card information directly in association with this particular transaction.

The communications described herein may be time-stamped, digitally signed, encrypted, authenticated, and so on. Both customers and businesses receiving such communications may be able to verify the authenticity and/or integrity of such communications and the sender thereof. Unlike existing alternative (i.e., e-mail, instant messaging, text messaging, etc.), there is no public address or interface to the communications channel. Thus, there is no way (absent malicious intrusion) for any third party to use the closed-circuit communication channel. In embodiments, this provides a completely effective measure against spam or unsolicited messages.

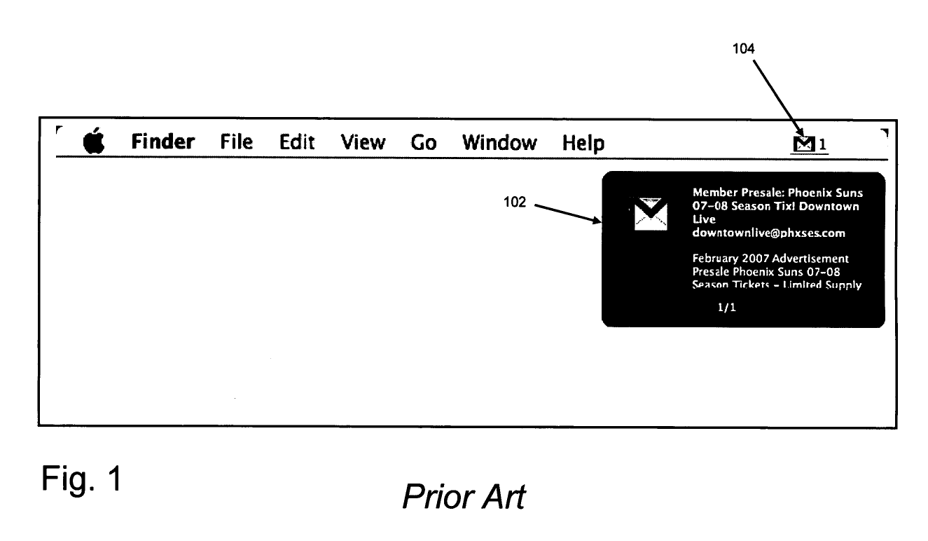

Referring now to FIG. 1, a prior art email alert pop-up 102 is shown in association with an email alert menu bar icon 104. Both the pop-up 102 and the icon 104 are associated with an email account. When a new email message arrives in the account, the pop-up 104 appears, indicating that the message has arrived and displaying the title of the message along with a snippet from the email. The number in the icon 104 indicates the number of unread messages in the email account. The appearance of the pop-up may be associated with a concurrent alert sound. In embodiments, a user may click on the pop-up 102 to make it disappear. In embodiments, the user may click on the icon 104 to view a pull-down menu of options, to open a web-based application that provides access to the email account, and so on.

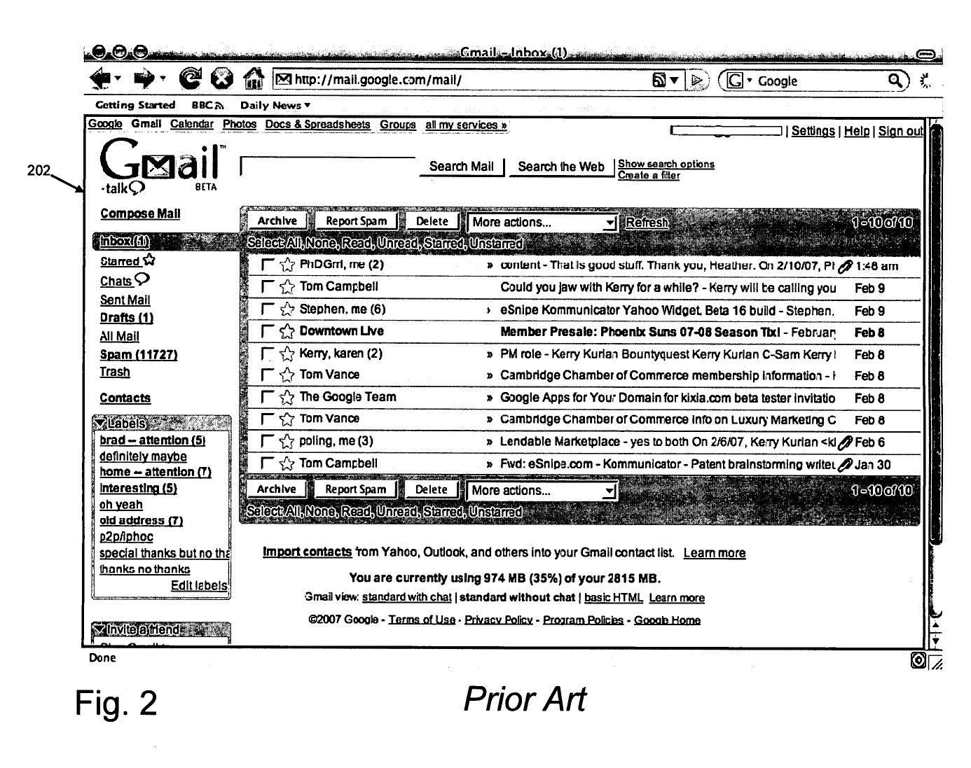

Referring now to FIG. 2, a web interface 202 of a prior art web-based application that provides access to an email account is shown. Those skilled in the art will appreciate the functions and features of the web interface 202. It is worth noting that no business transactional features are present and that no authentication features are present.

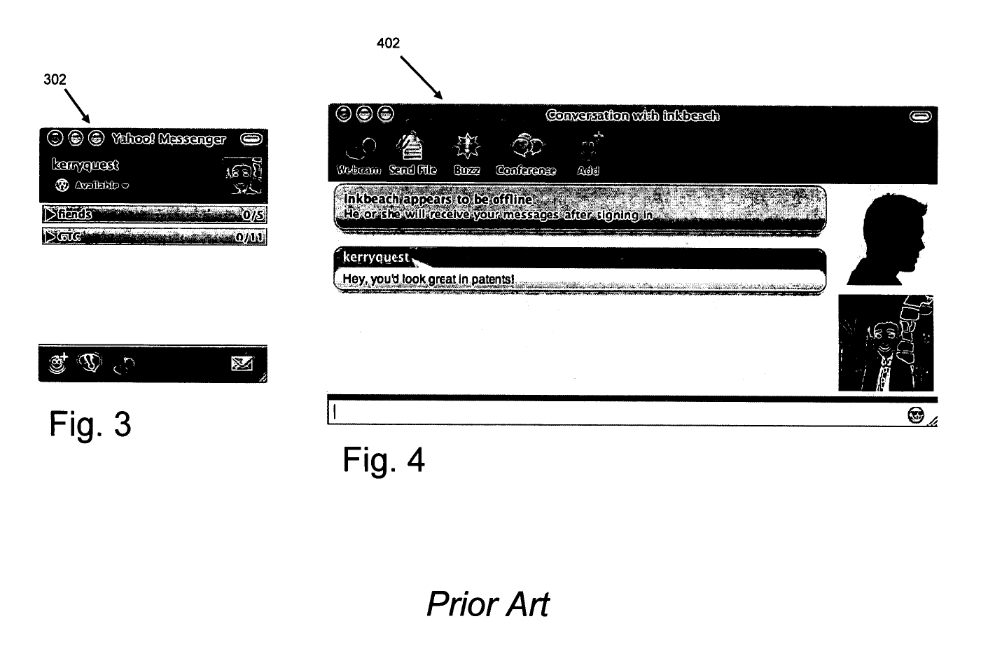

Referring now to FIG. 3, a main window 302 of an instant messaging client is shown. The name “kerryquest” may be a user name that is associated with a user of the client. The “available” keyword and icon may be associated with a status of the user. In this case, the user is indicating that he is available for chatting. Other options such as “unavailable,” “out to lunch,” and so on may be provided via a pull-down menu that appears when the user selects the down arrow next to the keyword. Categories may be associated with sets of users with which the user frequently communicates. The “0/5” and “0/11” text may indicate that zero of five users in a “fiends” category are presently online. Other functions and features of the main window 302 for an instant messaging client are known and will be readily appreciated from the foregoing description.

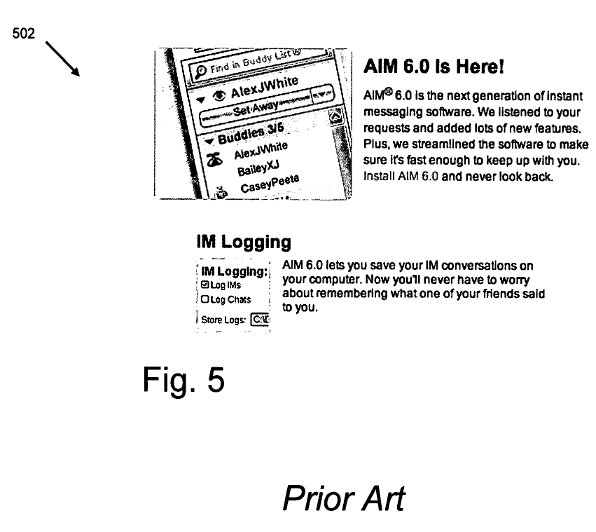

FIG. 4 shows a chat window 402 of an instant messaging client. It will be appreciated that this window 402 embodies a chat session between kerryquest (a user of the application) and inkbeach (a remote user of this or a compatible instant messaging client). The user inkbeach is not presently online and so a store-and-forward facility that is associated with the application may be used to receive the message from kerryquest to inkbeach and store that message for future delivery to inkbeach.

FIG. 5 shows an advertisement 502 for an instant messenger. A feature of this messenger is called “IM Logging” and it “saves your IM conversations on your computer.”

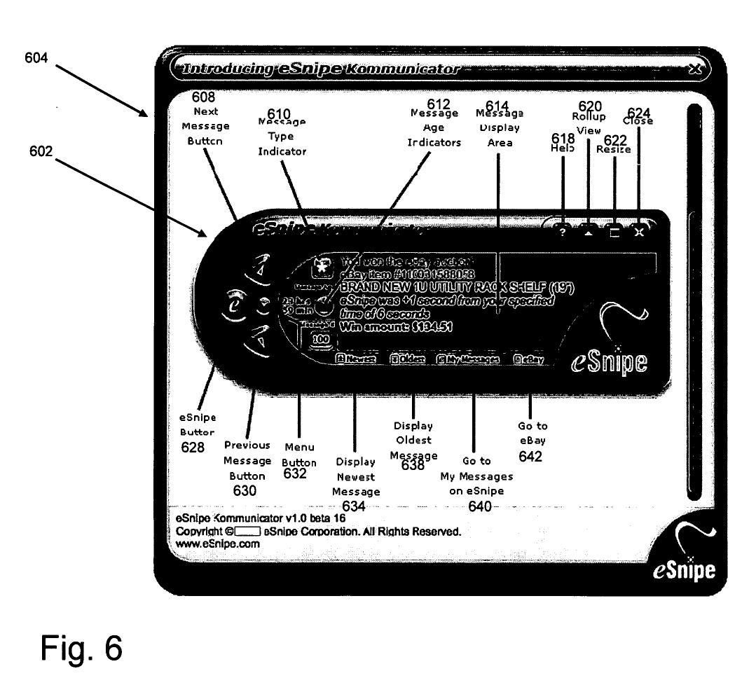

Referring now to FIG. 6, an embodiment of a virtual closed-circuit communications widget (CLIENT) 602 is shown. This embodiment relates to an application in which users receive information related to bids that are automatically placed in an online auction by a third-party bidding service. In the present example, which is provided for the purpose of illustration and not limitation, the online auction is operated by an online auction system (eBay in this example) and a bids are placed by a third-party bidding service (eSnipe in this example). Without loss of generality, and references in the following description to eBay should be understood to refer more generally to any online auction system, and any reference to eSnipe should be understood to refer to any third party bidding system. Still more generally, any consumer and business may communicate using the techniques described herein.

Moreover, although a widget embodiment is described in detail, it will be appreciated that any application providing a suitable user interface such as that of the widget 602 may be used in addition to or instead of the widget 602. For example and without limitation, the application may comprise a client-side application, a server-side application, a client-server application, a web-based application, an embedded application, a physical device (or consumer electronics device) that embodies the application, and so on. Many other embodiments will be appreciated by one of ordinary skill in the art, and all such embodiments are intended to fall within the scope of the present disclosure.

More specifically, FIG. 6 depicts a help window 604 associated with a widget 602, the help window 604 providing a number of labels for various elements of the widget 602. These labels are associated with a next message button 608, a message type indicator 610, a message age indicator 612, a message display area 614, a help button 618, a rollup view button 620, a resize button 622, a close button 624, an business button 628, a previous message button 630, a menu button 632, a display newest message button 634, a display oldest message 638, a go to my messages button 640, a go to third-party button 642.

A message may be displayed in the message display area 614. This message may be provided by a business and may be directed at a customer who is using the widget 602. In the current example depiction, the message pertains to a winning bid that was placed in an eBay auction by eSnipe. Included in the message is information that describes the accuracy with which the winning bid was placed by eSnipe (“eSnipe was +1 second from your specified time of 6 seconds”).

In embodiments of the widget 602, a user may activate any or all of its elements. Such selection or activation may occur via a user action, such as and without limitation a point-and-click action; a spoken word or phrase; a keyboard shortcut or combination of key presses; a gesture or other motion; and so on. A computing facility that provides the widget 602 may receive the user action via a mouse, keyboard, still-image interface, video interface, accelerometer, microphone, and the like.

Activation of the next message button 608 may cause the widget 602 to display the next message in a sequence of messages.

Activation of the message type indicator 610 may toggle between different message type indications. Such indications may vary from application to application. In the case of the present example, the indications may be associated with a winning bid, a losing bid, an error message, an alert message, and the like. In embodiments the indication of the message type indicator 610 may be driven by the message in the message display area 614. For example, if the message in the message display area 614 is an error message then the indication of the message type indicator 610 may be that of an error message. In embodiments the indication of the message type indicator 610 may drive the types of message that appear in the display area 614. For example, if the indication of the indicator 610 is that of an error then only error messages may be displayed in the display area 614.

Activation of the help button 618 may cause a help message, window, or other help indication to be displayed, spoken, or otherwise presented to the user.

Activation of the rollup view button 620 may cause the appearance of the widget 602 to change to an alternate, roll-up view (also referred to as a minimized view). Such a view is described in greater detail hereinafter with reference to FIG. 10 and elsewhere.

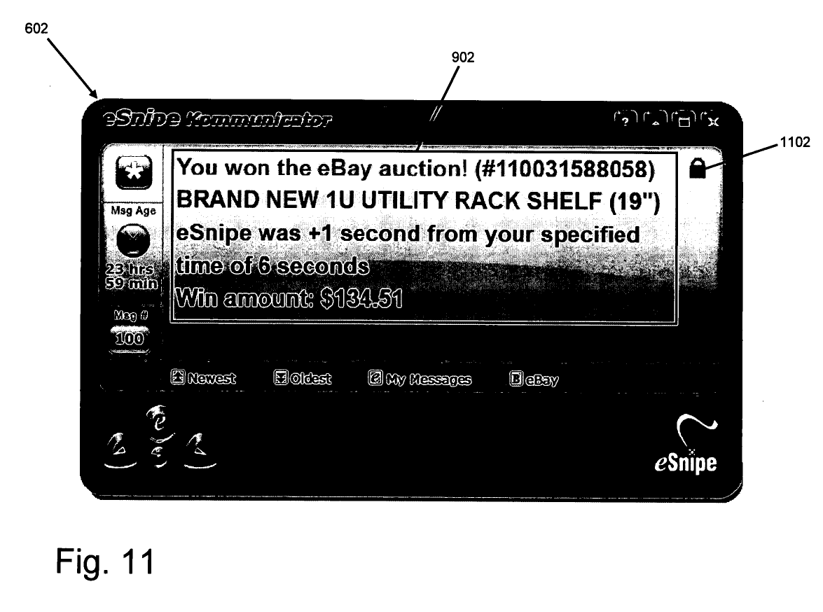

Activation of the resize button 622 may cause widget 602 to toggle from the present view to an alternate view. In the following description, three specific views are provided included a standard view that appears in FIGS. 6, 7, 8, 9, 12; a minimized view that appears in FIG. 10; and a maximized view that appears in FIG. 11. It will be understood that these views are example only, and that other sizes of views and configurations of feature options and controls may similarly be provided without departing from the scope of this disclosure.

Activation of the close button 624 may cause the widget 602 to disappear from a graphical user interface. Such disappearance may or may not be associated with deactivation of the widget 602. In other words, in some embodiments, the widget 602 may or may not continue to operate in the background as a process, thread, daemon, application, hidden element, or the like. In order to maintain continuous presence, a launcher or the like may alternatively operate in the background in order to launch the widget 602 in response to an incoming communication.

Activation of the business button 628 may cause a window (such as and without limitation a web browser window) to appear. In the window, a page (such as and without limitation a web page) that is associated with a business may appear. The business may be associated with a product or service that is promoted, mentioned, or otherwise associated with the message that appears in the message display area 614. In the depiction, the business button 628 is labeled “eSnipe button” to indicate that the business is eSnipe. In embodiments, the business may be any business.

Activation of the previous message button 630 may cause the widget 602 to display a previous message in a sequence of messages.

Activation of the menu button 632 may cause a pull-down menu or other menu of options to appear. Such a menu of options is described, for example, with reference to FIG. 15 below.

Activation of the display newest message button 634 may cause the newest message in a sequence of messages to appear in the message display area 614.

Activation of the display oldest message button 638 may cause the oldest message in a sequence of messages to appear in the message display area 614.

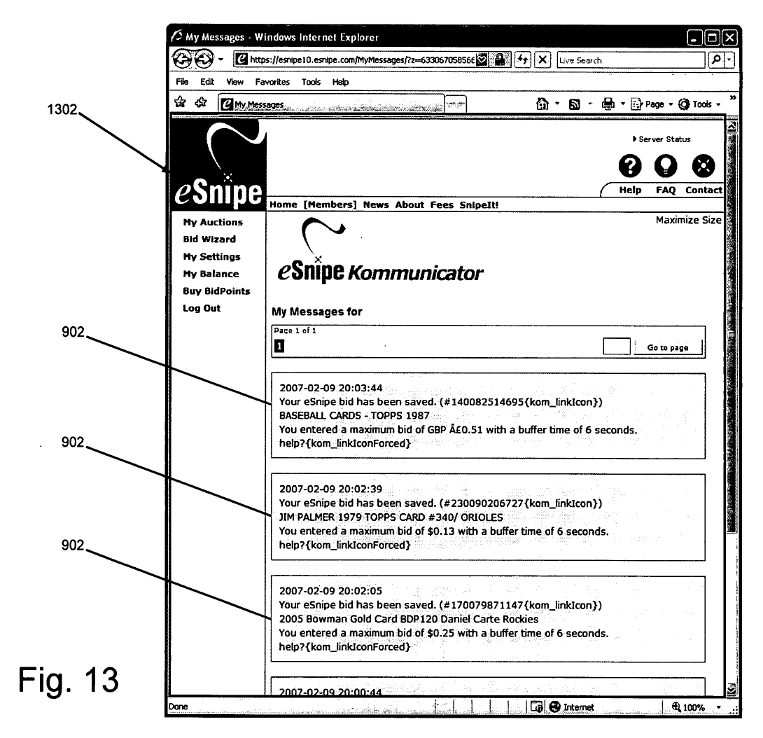

Activation of the go to my messages button 640 may cause a window (such as and without limitation a web browser window) to appear. The window may display messages and related information, as shown and described, for example, with reference to FIG. 13 below.

Activation of the go to third party button 642 may cause a window (such as and without limitation a web browser window) to appear. The window may display a corresponding web page associated with a third party which may, for example, be a web page related to messages within the widget 602.

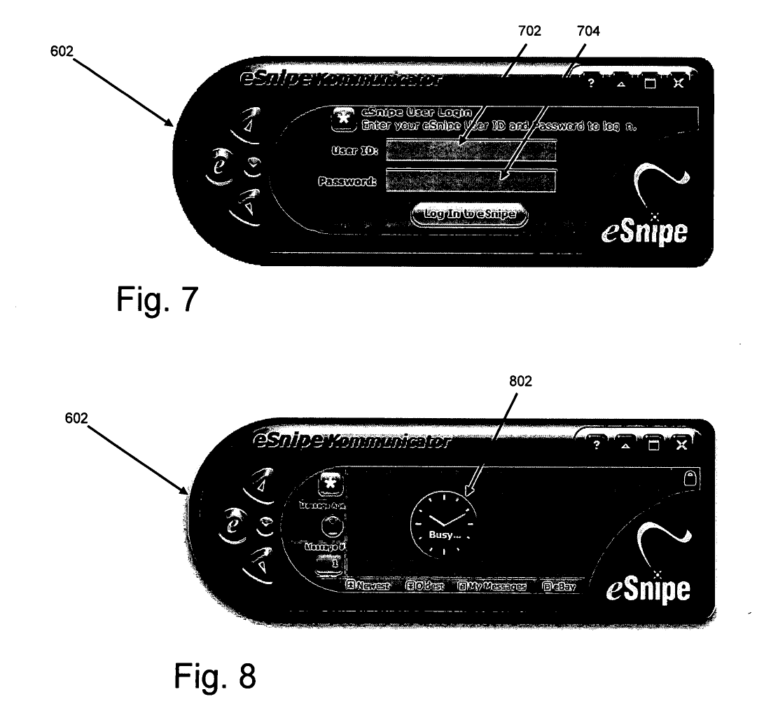

Referring now to FIG. 7, embodiments of the widget 602 may provide a user id field 702 and a password field 704. These fields 702 and 704 may be associated with a third party service used by the widget 602, such as to enable authenticated communications with or access to the third party service. For example and without limitation, a third party that communicates with a user via the widget 602 may require or request the user id and password so as to authenticate the user. Such authentication may occur at any point during a communication. The communication may be associated with customer support, a transaction, or any and all other kinds of communication. The user id field 702 and password field 704 may be associated with a single sign-on function supported by the widget 602. The single sign-on service may allow the user to provide one user id field 702 and password field 704 that are associated with granting, allowing, or providing user access to and/or authentication that is required or requested by a service, function, feature, third party web site, or the like. The user id field 702 and password field 704 may be presented to the user during a transaction, such as and without limitation prior to a purchase.

The user id field 702 and password field 704 may be associated with granting access to and/or modifying personal information, preferences, and the like. These may be stored locally with respect to the widget 602 and/or stored remotely at a server or third party that is associated with the widget 602. The information, preferences, and the like may be stored in an encrypted or unencrypted form, or may be stored indirectly as a hash value, or using any other suitable technique(s). The personal information and preference may, without limitation, be associated with a credit card, bank account, PayPal or other online money transfer account, a billing system, an invoicing system, a payment system, a reimbursement system, a time tracking system, a shopping preference, a buying preference, a shipping preference, an order history, a shopping cart, an automatically generated suggestion, a wish list, a viewing preference, a rating, a reputation, and so on.

FIG. 8 shows an idle display. In embodiments, the widget 602 may periodically spend time processing, retrieving, transmitting, or otherwise handing or waiting to handle information. During this time some or all of the features or functions of the widget 602 may be more or less unavailable to the user. In these cases, the widget 602 may display a clock icon 802 or the like that provides the user with a visual indication that some or all of the features or functions of the widget 602 are unavailable (or partially available). An audible tone or other indicator may be concurrently provided to alert a user to changes in widget status.

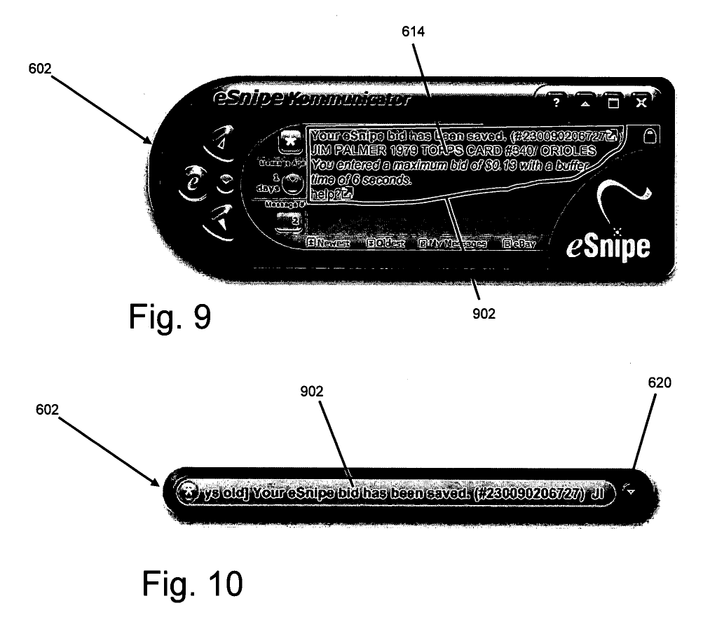

Referring now to FIG. 9, embodiments of the widget 602 may display a message 902 in the message display area 614. The message 902 may be one of a series of messages. The message 902 may be singular. The message 902 may be part of a one-way or two-way communication between a user of the widget 602 and a third party, a service provider, or the like. The message 902 may include hyperlinks. The message 902 may be presented in association with a style, a skin, a style sheet, or the like. The message 902 may be accompanied by and/or associated with an aural representation of the message (such as and without limitation a text-to-speech rendition of the message). The message 902 may include text or other aspects that are provided by the user of the widget 602. For example and without limitation, the user may enter text via a keyboard, audio via a microphone, gestures via a pointing device (such as and without limitation a track point, mouse, touch pad, stylus, or the like), and so on. Such entries may appear in and/or be associated with the message. Indications of such entries may appear in or in association with the message 902 as an icon, emphasis, color, or the like. For example and without limitation, when the message 902 contains audio a speaker icon may appear alongside the message 902.

Referring now to FIG. 10, an embodiment of a minimized widget 602 is shown. In this embodiment, the visual size of the widget 602 is reduced as compared with other embodiments. The message 902 may be displayed as a crawler. The rollup view button 620 may be provided, but any and all of the other buttons may be absent. The minimized view may allow a user to monitor and/or enter messages while using a reduced amount of screen space and, perhaps, while exposing a relatively limited set of functions. In embodiments, the minimized view may comprise a visual and/or aural indication that is rendered when a new message 902 or a message requiring immediate attention 902 becomes available. For example and without limitation, a bell sound may play when a new message 902 arrives. The message 902 in the minimized view may be abbreviated as compared with the message 902 that may appear in other views. In embodiments, double-clicking on the minimized view may perform a function that is similar or equivalent to activating the rollup view button 620, the resize button 622, the close button 624, and so on.

Referring now to FIG. 11, an embodiment of a maximized widget 602 is shown. In this embodiment, the visual size of the widget 602 is increased as compared with other embodiments. A lock icon 1102, which may appear in any and all of the embodiments of the widget 602, may be provided. This icon 1102 may indicate that the message 902 in the message display area 614 is final, fixed, locked, unchangeable, unchanging, and the like. This icon 1102 may indicate that a communication that is associated with the widget 602 and/or the message 902 in the message display area 614 is one-way to the user (so, the user may not provide and the widget 602 will not accept communications that are directed at the source or provider of the message 902). The lock icon 1102 may indicate that the widget 602 is locked so that any and all of the features, functions, buttons, and the like of the widget 602 are not functional. The lock icon 1102 may indicate that the communications presently being provided by the widget 602 are secured, such as and without limitation according to SSL, SSH, and the like.

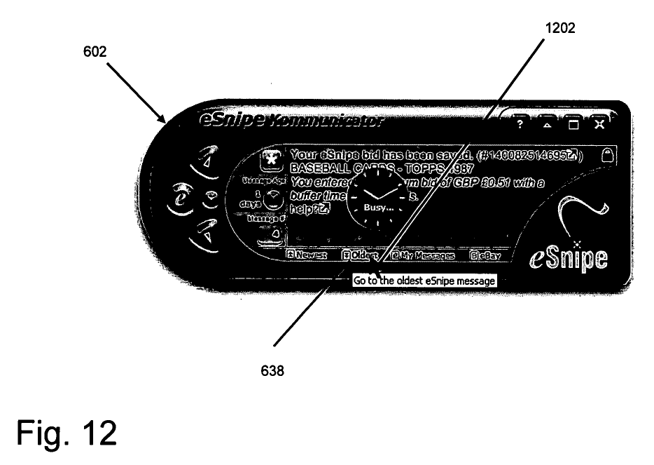

Referring now to FIG. 12, a user may interact with the widget 602 by positioning a pointer 1202 over an element of the widget 602. In this example, the user has positioned the pointer 1202 over the display oldest message button 638. As the pointer 1202 hovers over this button 638, metadata or a description of the button 638 may appear. In the present example, the description is “go to the oldest eSnipe message.” It will be appreciated that any and all aspects of the widget 602 may be associated with metadata and/or descriptions and the user may interact with such aspects in a similar or identical manner as that described here or elsewhere. All such interactions, metadata, and descriptions are within the scope of the present disclosure.

Referring now to FIG. 13, a message history web page 1302 may contain a plurality of messages 902. The plurality may be a series and, when this is the case, the series of messages 902 may be displayed sequentially in chronological or reverse-chronological order. The message history web page 1302 may provide a legacy, supplementary, and/or alternative way for a user to view messages 902. The message history web page 1302 may be provided by a provider of the messages 902, a third party that is associated with communicating the messages 902, and so on. The message history web page 1302 may be displayed when the user activates the business button 624. The message history web page 1302 may be displayed by an application that is integral to the widget 602, associated with the widget 602 (such as and without limitation a helper application or a default application), and so on. The widget 602 may contain or be associated with a preference that indicates which application should display the message history web page 1302. This preference may be a system-wide preference, a user-specific preference, a default preference, or the like.

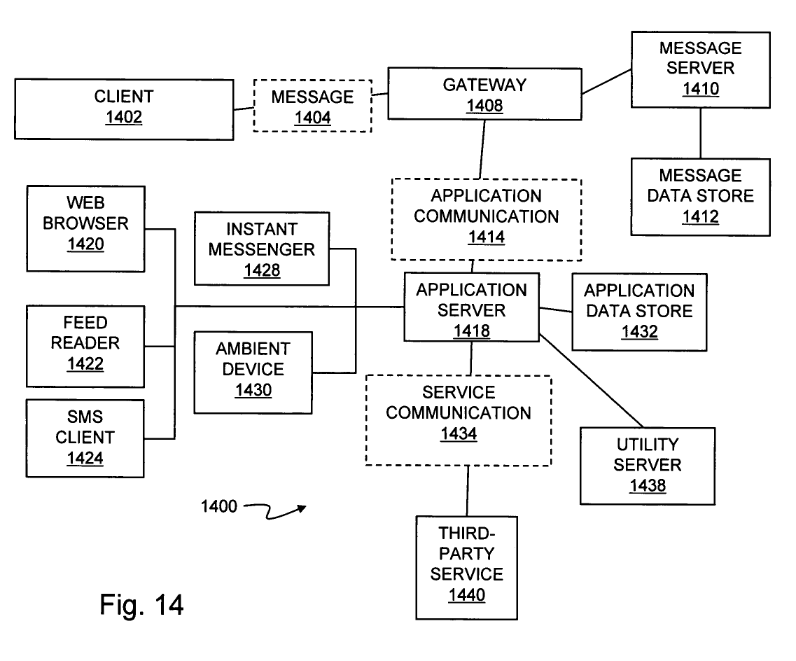

FIG. 14 shows a closed-circuit communications system that supports communications and services in association with the widget 602 and similar communications clients. The system 1400 may include a closed-circuit communications client 1402 that sends or receives a message 1404, a message communications gateway, a message server, a message data store 1412, an application communication 1414, an application server 1418, a client (such as a web browser 1420, a feed reader 1422, an SMS client 1424, and instant messenger 1428, an ambient device 1430 and the like), an application data store 1432, a service communication 1434, a utility server 1438, and a third-party service 1440.

The closed-circuit communications client 1402 may be, for example, any of the widgets 602 described above, or any similar client software or device suitable for closed-circuit communications as described herein. The client 1402 may support a variety of features and functions such as token-based login, a navigation index, lock and auto-hold navigation, bandwidth throttle, logging, tagging, watchdog, advertising, clock-drift compensation, dynamic activity loading, command/control, automatic updates, skins, session tracking, personal communications, chart rendering, and so forth. In general, the closed-circuit communications client 1402 communicates with the message communications gateway 1408 using a message 1404. Various features of the client 1402 are now described in greater detail.

The token-based login may allow a user to log into or otherwise access a communication, application, or service. The token-based login may involve a token, cookie, or the like that is stored in or that is associated with the client 1402. When access to a communication, application, or service required a user to first log in, the token may be transmitted in lieu of or in addition to information that is associated with an alternative login method. The token-based login may enable the establishment of a secure and tamper-resistant way to share a login or login information between two independent yet related systems. Systems and methods for registering a token that can be used as an entry method into a website are known in the art and are intended to fall within the scope of the present disclosure.

In embodiments two or more independent services may share a common login database, but not common session management. In such embodiments, there may be a need for one session that is established with one of the services to be trusted by a second one of the services. A token-based login may provide a way to log in to the second one of the services without a user name and password. Instead, the token-based login may provide a trusted relationship between the services. For example and without limitation, an email site may be associated with a user account and an online support forum. The email site and the online support forum may encompass two independent services. A user who is logged in at the email site may want to be able to jump over to the online support forum and post a message as himself, without having to first log into the support forum. With a token-based login this may be possible. In another embodiment, one of the services may be an online service such as a project management service, a time tracking service, a photo sharing service, a video sharing service, and so on, and the second one of the products may be an online customer support center. In such an embodiment, when a user jumps over from the online service to the customer support center, the token-based login may allow the customer support center to automatically know the user's identity without requiring the user to separately log into the support center. More generally, the token-based login approach or any similar technique may be employed to permit a user to maintain a single identity across multiple services without requiring separate logins for each service.

A token-based login may be associated with encryption, a time out, unique user information, and the like. For example and without limitation, a token-based login may use an encrypted, time-sensitive token that is renewed each time the user utilizes a service. If the token times out or expires due to a lack of activity, the user may be prompted to enter a user name, password, secret, or the like so as to authenticate the user prior to the issuance of a new token. Alternatively or additionally, the user may be prompted to place a telephone call, visit a web site, or take some other action that is associated with authenticating the user and/or reissuing a valid token for the user.

In embodiments, a token-based login may be associated with tracking a user's online activities such as and without limitation for advertising purposes. Here, the token-based login may allow an advertising application to identify and track a user who is logged in with an independent application.

In embodiments, the token-based login may be implemented as a server-to-server communication that allows independent applications to validate a login, a time of a login, and so on. For example and without limitation, in the case of an email application that is associated with an online message forum application, a user may log in to the email application and from time to time jump over to the online message forum. When the user first logs into to email application, a token may be issued to the user (or a computing facility that is associated with the user). When the user jumps over to the online message forum, the forum may receive the token and then pass the token via a public, protected, or private communication channel to the email application. The email application may recognize the token as authentic and may return to the online message forum application and indication of such. The indication may be formatted, e.g., according to XML and may contain a confirmation or acceptance code, metadata about the user, metadata about the token, and so on.

In embodiments, a central repository or trusted authority may grant, revoke, validate, invalidate, and otherwise process tokens for token-based login. For example and without limitation, an email application and a customer service forum application may communicate with the central repository or trusted authority to validate or identify a user or a user session. In such embodiments, the user may first log into or otherwise be authenticated by the central repository or trusted authority. Then, the user (or a computing facility associated with the user) may receive a token from the central repository or trusted authority. Upon accessing the email application or customer service forum application, the token may be provided to such application. In turn, an application may transmit the token to the central repository or trusted authority for verification, validation, or the like. The repository or authority may transmit an acceptance, denial, limitation, or other approval or disapproval code or string back to the application. In embodiments, the code may be encoded in XML and may be included along with metadata that is associated with the user.

Many other embodiments and applications of the token-based login will be appreciated and all such embodiments are within the scope of the present disclosure.

The navigation index may comprise, encompass, or be associated with a numbering system for prioritizing, sorting, categorizing, selecting, or otherwise managing groups of messages. In embodiments, the prioritizing, sorting, categorizing, selecting, and so on may be relative. In embodiments, the particular messages may be recent messages, messages from a particular time period, messages associated with a particular user, messages associated with a particular activity (e.g., bidding, buying, browsing, and so on), and so forth.

In various applications for communication—such as and without limitation instant messaging, email, blogging, and the like—information may be associated with a sequence or tree of messages that gets larger over time, potentially without bound. Instant messaging applications, paging applications, SMS or text messaging applications, and the like provide a limited window into content—either one message at a time or just a few messages at a time. In embodiments, users may employ such applications and/or systems when the information being conveyed is time sensitive. In such embodiments, the navigation index may be keyed to time of message creation, time of message delivery, age of message, or the like. In such embodiments, a database may store a messages age and that age may be updated from time to time.

The lock-and-hold navigation may be associated with a message display area 614 that automatically updates itself, such as and without limitation to display the most recent message 902. A user may usually be interested in seeing the most recent message 902, but in some cases may want to see a particular other message 902. To facilitate this, the lock-and-hold navigation may cause the message display area 614 to hold a particular message 902 indefinitely, for a fixed amount of time, until a signal to display the lock-and-hold navigation is received, and so on. The lock icon 1102 may be associated with the lock-and-hold navigation. In embodiments, the lock icon 1102 may indicate that the lock-and-hold navigation is enabled. In embodiments, the lock icon 1102 may be a user interface feature that a user may activate or deactivate to enable or disable the lock-and-hold navigation. In embodiments, the lock-and-hold navigation may automatically be enabled with the user navigates to a particular message 902, such as and without limitation when the user activates the previous message button 630, the next message button 608, the display oldest message 638, and so on. In embodiments, a sound may be played when a new message 902 arrives at the client 1402 and the lock-and-hold navigation is enabled. This may serve to alert a user of the new message's arrival without interrupting the user's view of the message 902 that is already in the display area 614.

The bandwidth throttle may be controlled by a signal from a server indicating, for example, that the server is busy and, perhaps, the degree to which the server is busy. The client 1420 may use this information to limit or be more selective about how much fetching or prefetching the client 1402 is doing from the server. In embodiments, the bandwidth throttle may be applied to an instant messaging-type system in which the client 1402 polls the server for new messages. The server may, for example, include the message server 1410, the application server 1418, the message communications gateway 1408 or any other network component that might provide useful availability information to the client 1402. In embodiments, a method by which the client 1402 may be more selective in fetching or prefetching from the server may comprise the client receiving a plurality of inputs from a user, each one of the inputs usually associated with a fetching or prefetching action, and the client compressing those inputs into a single fetch or prefetch action. For example and without limitation, a user may provide a plurality of inputs to the client by activating the next message button 608 a plurality of times in rapid succession. Each of the activations may be associated with the client fetching the next message 902 from a server. However, in response to an indication received at the client from the server, the bandwidth throttle may fetch just the one message 902 that is associated with the last of the plurality of inputs.

The logging may be associated with a client-side logging facility that may log any and all events, actions, and the like that occurs on the client. The logging facility may log application-level events including application crashes, application usage patterns, inputs received at the application, outputs produced by the application, system utilization by the application, application updates, exceptions thrown and/or caught by the application, and so on. The logging facility may produce a client-side log or file containing information that describes or is otherwise associated with the logged events. The logging facility may, from time to time, upload the log to a central server or other facility. The central server or some other facility my transmit commands, suggestions, instructions, or the like to the logging facility so as to direct the logging facility to log particular events, more events, fewer events, and so on. Similarly, a user may provide an input or take some other action that likewise instructs the logging facility. In embodiments, the logging facility may be activated or deactivated at certain times, such as and without limitation according to a schedule. In embodiments, the log may supplement a crash report such as and without limitation to provide information about the state of an application leading up to a crash, a context in which the application was operating up until and perhaps during and/or after a crash, or other information surrounding, associated with, leading up to, encompassing, and/or following the application's crash. The logging may be associated with a diagnostic facility, which may receive logs from one or more logging facilities and provide a diagnostic function or capability that is associated with and/or driven by the logs. For example and without limitation, the logs may contain system information describing the types and/or configurations of systems on which an application is running. The diagnostic facility may examine the system utilization and/or other performance measures of a plurality of instances of the application and produce a histogram or other output that correlates the performance measures with types and/or configurations of systems. Many other diagnostic functions will be appreciated and all such functions are within the scope of the present disclosure. Many kinds of information and events that can be logged by the logging facility will be appreciated and all such information and events are within the scope of the present disclosure.

The watchdog may automatically observe the behavior of an application. The behavior may be associated with system resource utilization (including without limitation CPU, disk, memory, and other system resource utilization), code execution analysis, memory access vis-á-vis memory fences, application performance, and so on. The watchdog may analyze the behavior and/or look for particular behaviors so as to predict a future behavior of the application, recognize a failure or error condition in the application, and so on. In embodiments, the application may comprise the watchdog. In embodiments, a system on which the application is running may comprise the watchdog and the application may register itself with the watchdog. In embodiments, the watchdog may be software-based, hardware-based, software and hardware based, and so on. In embodiments, the watchdog may be statically linked to the application or dynamically linked to the application. In embodiments the watchdog may be associated with or comprise at least one aspect of the logging facility.

The advertising may include systems and methods for performing marketing-related actions over a closed-circuit instant messaging system, which may or may not include or be associated with the client 602. The advertising/marketing may be associated with providing a marketing promotion to or via a client 602. In embodiments, the client 602 may comprise a pager device such as and without limitation like those provided by a restaurant to patrons who are on a waiting list to be seated. The advertising/marketing may comprise systems and methods for ensuring the equal delivery of marketing promotions, including without limitation measurement of delivery successes, delivery failures, and the like. The advertising/marketing may comprise or be associated with a confirmation system that provides an indication of whether and how many marketing messages were delivered, will be delivered, failed to be delivered, and so on. The systems and methods of advertising/marketing may be associated with a plurality of methods for one to receive a marketing message and/or respond to a promotion. In embodiments the promotion may include a give-away offer that provides an entrant with something for free.

Clock-drift compensation may be associated with synchronizing a plurality of client clocks with one another. Alternatively or additionally, clock-drift compensation may be associated with synchronizing a client clock with a particular clock, such as and without limitation a server clock, an atomic clock, a client clock, and the like. Clock-drift compensation may provide centralized and/or distributed knowledge of how for off a client's clock is from a reference clock, wherein the reference clock resides some distance away from the client's clock across a best-effort data delivery network (such as and without limitation the Internet). In embodiments, clock-drift compensation may perform a calibration process on startup. For example and without limitation, the process for clock-drift compensation may involve a first step of querying a server to retrieve a time. This step may be repeated any number of times, such as and without limitation four times. A minimum amount of time may elapse between repetitions of this step. In embodiments, the minimum amount of time may be three seconds or any amount of time. The next step in the process may involve taking the smallest difference between the client clock and the reference clock and assuming that this time incorporates the fastest known network transmission time. It will be appreciated that the actual network transmission time may not be known and so this smallest difference, which may incorporate network delay or transmission time in addition to the actual difference between the client clock and the reference clock, may represent the best estimate of the actual different between the client clock and the reference clock. In embodiments, clock-drift compensation may perform the calibration process once a day or on any other suitable regular or irregular schedule. In embodiments, a message may contain an element, field, or the like that may reference a time-dependent event, such as and without limitation the end of an online auction. A process for clock-drift compensation may automatically adjust the element, field, or the like so that it is compensated for any and all clock drift between the client clock and the reference clock. Many embodiments and variations of clock-drift compensation will be appreciated and all such variations are within the scope of the present disclosure. It will be appreciated that clock-drift compensation may be utilized in many applications, including without limitation Digital Video Recorders (DVRs), software applications, and so on. All such applications are within the scope of the present disclosure. While being generally useful for synchronized activities, clock-drift compensation has particular utility for time sensitive applications such as automated bidding in online auctions.

Dynamic activity loading may comprise transmitting an instruction from a server to a client, the client periodically or from time to time polling the server. The instruction may indicate to the client that it should poll the server less frequently or according to a schedule. In response to receiving the message, the client may poll the server less frequently or according to the schedule.

The command control may comprise a system or method that enables a server to issue commands (such as and without limitation software update commands) to a plurality of clients, wherein the issuance of commands and/or other actions associated with the issuance of the commands are queued. An advantage of such queuing may be appreciated by considering the following example: When an update to a widely used software application is released, a server may transmit an update message or command to any and all installations of the software application. In response to the update message, the installations of the software application may attempt to retrieve the update from one or more network file servers. It will be appreciated such coordinated attempts to retrieve the update may result in what amounts to a distributed denial of service attack against the file servers. If, however, the transmission of the update message is queued then an instance of the message may be placed in a queue for each and every one of the installations. A transmission agent or application may retrieve the instances of the messages from the queue and transmit them to the associated installations according to a fixed rate, an adjustable rate, or the like. As a result, the each of the installations may receive the message at a different time and according to the rate (as opposed to all the installations receiving the message more or less at once as may be the case without queuing). It follows that the retrievals may occur over time and more or less according to the rate. The rate may be selected so that the retrievals do not result not overload the file servers. Similarly, a queue may be employed at the file servers so that attempts to retrieve the update are queued and then serviced according to the rate. It will be appreciated the command control may be applied generally to any and all circumstances in which a server is issuing a command to a client, a client is attempting to access a resource (such as and without limitation a file resource, a network resource, a computing resource, a memory resource, an operating system resource, a physical resource, a virtual resource, and so on), and so forth. All such circumstances are within the scope of the present disclosure. Although the present example relates to software updates and associated file retrievals, it will be appreciated that the command control is in no way limited to applications involving software updates, file retrievals, and so on.

The auto-update provides for updating the client 1402, such as and without limitation by enabling the download or installation of modified, improved, fixed, or otherwise enhanced versions of an application, library, script, or other executable, interpretable, or configuration element of the client 1402. Such download or installation may occur according to or in association with an automatic process and may be referred to as an automatic update. The automatic update may be initiated at a server facility (an “update server”) that distributes, affects, initiates, completes, or otherwise enables the automatic update for a plurality of client or other applications, including without limitation clients 1402 or other applications running on or in association with a heterogeneous set of computing facilities, operating systems, configurations, preferences, and so on. In embodiments, the auto-update may be designed or deployed in a manner that prevents, reduces, hampers, or otherwise limits a third party's ability to exploit the auto-update for malicious purposes, such as and without limitation for the purposes of installing a virus, worm, Trojan horse, spyware, malware, adware, and the like. Auto-update may be software that is a component, aspect, element, or other integrated, loaded, linked, interpreted, or otherwise incorporated into the client 1402. In embodiments, auto-update update may allow the entire client 1402 to be replaced. In embodiments, auto-update may allow a component of the client 1402 to be replaced. In embodiments, auto-update may be applied to an operating system, system software, network software, graphics software, application software, game software, productivity software, office software, software that is provided as a service, software that is deployed within a service oriented architecture, software that is interpreted, software that is compiled, software that is executed, software that is assembled, software that is disassembled and then reassembled, software that is loaded and linked at runtime such as and without limitation a dynamically linked library, software that is loaded and linked at compile-time such as and without limitation a statically linked library, software that is interpreted in a client such as and without limitation a JavaScript application that operates within a web browser in accordance with the AJAX programming paradigm, and so on.

A testing facility may be provided to test automatic updates across a variety of hardware and software configurations. An update server may publish a list of available updates so that the client or a related application can receive and evaluate the updates. Load balancing may be provided to distribute large scale updates in an environment with numerous instances of the client 1402, such as by scheduling when instances are notified of updates or scheduling when client instances request updates. A client 1402 may report the status of updates back to an update server that maintains a database of the update status of client instances.

A skin may be associated with the client 1402. The skin may comprise a view (that is, information that directs the appearance) of the client 1402. In embodiments, the skin may be encoded as a graphics file, an audio file, an XML file, an OPML file, a configuration file, a style sheet, a cascading style sheet, and so on. Many embodiments of the skin will be appreciated and all such embodiments are within the scope of the present disclosure.

Session tracking may be associated with the client 1402. Session tracking may encompass systems and methods for enabling or tracking an online session. The online session may, without limitation, comprise a series of related events, web page views or posts, user interactions, or the like. In embodiments, the related things in an online session may depend in some way upon one another. For example and without limitation, an online session may comprise a successful user login followed by a page view followed by a web page post. In this example, the web page post may depend upon a user receiving a form in the page view and the page view may depend upon the successful user login. In embodiments, session tracking may be implemented using cookies, URL rewriting, hidden form fields, servlets, and the like, as well as combinations of the foregoing. Numerous techniques for session tracking are known in the art and may be suitably adapted to the methods and systems described herein.

Personal communication may be associated with the client 1402. Personal communication may comprise point-to-point text messaging, voice messaging, video messaging or conferencing, file transfers, interactive document editing, any and all combinations of the foregoing, and so on. Personal communication may comprise multi-party communications such as multi-party communications involving text, audio, video, file transfers, interactive document editing, and combinations of the foregoing. Personal communication may be directed at providing a user with secure, trusted, authenticated, privileged, safe, reliable, dependable, public, protected, private, or other communication. In embodiments, personal communication may occur between a user and another user, between a plurality of users, between one or more users and an automated service (or “bot”), between a plurality of users and a bot, and so on. In embodiments, the client 1402 may be associated with a plurality of personal communications, which may be presented to the user as a plurality of communications channels or the like. In embodiments, each and every personal communication may be associated with a commercial entity, a private entity, a sole proprietor, a corporation, an individual, and the like. In embodiments, the personal communication may be sponsored, free, subscription-based, access-controlled, associated with a pre-paid account that is debited on a per message or elapsed-time basis that is associated with a user's utilization of the client 1402 or associated personal communication, and so on.

Chart rendering may be associated with the client 1402. Chart rendering may comprise the converting information into a chart for presentation to a user. The chart may encompass a scatter chart, a line chart, a high-low chart, a bar chart, a pie chart, a histogram, an area chart, a bubble chart, a QC chart, a polar chart, a cluster chart, a vector chart, a mixed chart, an organization chart, a text chart, a two-dimensional contour chart, a three-dimensional scatter chart, a three-dimensional grid or column chart, a three-dimensional histogram, a three-dimensional surface chart, a four-dimensional contour chart, a contour chart, a scatter chart, a grid or column chart, a surface chart, and so on. In embodiments, the client 1402 may display the chart. The information that is converted into the chart may be associated with a message 1404, a user input, an aspect of the client 1402, any and all combinations of the foregoing, and so on. Many applications of chart rendering will be appreciated and all such applications are within the scope of the present disclosure. Many embodiments of chart rendering will be appreciated and all such embodiments are within the scope of the present disclosure.

The message 1404 may include an application-specific message, a logging message, a user tracking message, a preferences message, an authentication message, an error message, a diagnostic message, or any other type of message useful for communicating information between the closed-circuit communications client 1402 and the message communications gateway 1408 for realization of the systems and methods described herein. Each message 1404 may be automatically generated, manually generated, or some combination of these. In embodiments, any number and type of messages may be employed, with messages embodied as a packet, a string, an XML object or element, binary data, ASCII data, and so on. Many message types are known and may be suitably adapted to use with the systems and methods described herein.

The message communications gateway 1408 may exchange messages 1404 with the client 1402. The gateway 1408 may also exchange application communications 1414 with an application server 1418. The gateway 1408 may also be coupled in a communicating relationship with a message server 1410. In general, the gateway 1408 may support various communications types among these entities such as handling of incoming communications, outgoing communications, bi-directional communications, transactional communications, queue communications, immediate communications and the like. Further, communications may be 1-to-1, 1-to-n, and/or n-to-1. Returned now to the gateway 1408, the gateway 1408 may receive information in one form and then communicate the information in the form it was received, in an alternate form, in whole, in part, and so on. The message communications gateway 1408 may communicate one or more messages 1404 with the client 1402. The message communications gateway 1408 may communicate information with the message server 1410 and/or with the application server 1418. Communications between the application server 1418 and the message communications gateway 1408 may be embodied as an application communication 1414. In embodiments, the message communications gateway 1408 may be a gateway between two or more data networks that utilize different communications systems or methods. In embodiments, two or more of the message server 1410 the application server 1418, and the client 1402 may exist on the same data network or on different data networks.

According to one method that may be supported or otherwise associated with the message communications gateway 1408, the gateway 1408 may receive a message 1404 from the client 1402, and process the message including, for example extracting, converting, decoding, decrypting, parsing, interpreting, manipulating, storing, or otherwise processing the contents thereof. The gateway 1408 may also, or instead, create outbound messages based upon received messages, including processing such outbound messages into a format suitable for the intended recipient (e.g., the client 1402, message server 1410, or application server 1418). The gateway 1408 may also, or instead, receive information from the message server 1410 or application server 1418. After receiving the information, the gateway 1408 may format, convert, encode, encrypt, extract, access, decode, decrypt, process, manipulate, or otherwise form some or all of the information into a message 1404. The message 1404 may then or at some later time be communicated to the client 1402. More generally, the gateway 1408 may process incoming messages to support communication among the client 1402, message server 1410, and application server 1418.

The message communications gateway 1408 may operate in or according to one or more communications modes including, without limitation, an incoming mode, an outgoing mode, a bi-directional mode, a transactional mode, a queued mode, an immediate mode, a 1-to-1 mode, a 1-to-n mode, an n-to-1 mode, and so on. In the incoming mode, the gateway 1408 may receive communications. In the outgoing mode, the gateway 1408 may transmit communications. In the bi-directional mode, the gateway 1408 may receive and transmit communications. In the queued mode, the gateway 1408 may receive a communication and then put the communication into a queue from which the communication may be retrieved and then transmitted at some point in the future. In embodiments, the queue may comprise any and all kinds of queue including, without limitation, a first-in first-out queue, a first-in last-out queue, a priority queue, and so on. In the immediate mode, the gateway 1408 may transmit communications immediately or soon after receiving a related communication.

The message server 1410 may be operatively coupled to a message data store 1412. In general, the message server 1410 provides message-related services such as logging, preference tracking, preference applying, and authentication.

The application server 1418 may be operatively coupled to an application data store 1432. The application server 1418 may also be operatively coupled to a third-party service 1440 so that one or more service communications 1434 may be exchanged between the two. The application server 1418 may further be operatively coupled to a utility server 1436. The application server 1418 may be operatively coupled to a web browser 1420, a feed reader 1422, an SMS client 1424, an instant messenger 1428, an ambient device 1430, and the like. In general, the application server 1418 supports communications with various third-party services and/or client applications for delivery of customer support, instant messaging, auctions, sniping, purchasing, bulk purchasing, news feeds, electronic mail, business-to-consumer contacts, advertising, user tracking, web presentation, entertainment, price tracking, persistent storage, media delivery, media uploads, and so forth.

The utility server 1438 may support utility functions such as backup, synchronization, and logging for the application server 1418.

Without limitation, any and all of the operative couplings that are described with reference to FIG. 14 may include communications links such as TCP/IP (including Internet), Ethernet, WiFi, Bluetooth, WiMax, USB, Internet, LAN, WAN, MAN, VLAN, and so on. Physical communications links may be supported using wireless and/or wired communications links, electronic and/or optical links, digital and/or analog links, any and all combinations of the foregoing, and so on.

Numerous other client devices may be available on the physical device hosting the client 1402, or elsewhere in a system that might usefully communicate with the client 1402. This may include, for example, the web browser 1420, feed reader 1422, SMS client 1424, instant messenger 1428, and ambient device 1430 of FIG. 14.

The web browser 1420 may comprise Firefox, Internet Explorer, Safari, Opera, or any and all other web browser. The web browser may communicate with the application server 1418. In embodiments, such communication may occur via the HTTP, TCP/IP, and so on. The web browser 1420 may display information for a user. The web browser 1420 may accept information from the user. The web browser 1420 may process information that is encoded in or associated with HTML, XHTML, CSS, JavaScript, DHTML, XML, DOM, XSL, XSLT, RSS, AJAX, ASP, ADO, PHP, SQL, and so on. The web browser 1420 may encompass a standalone software application, an embedded software application, a software module that operates within another software application, a web application, and so on. Numerous web browser clients are known in the art and may be suitable adapted to the methods and systems described herein.

The feed reader 1422 may be an aggregator or news aggregator. The feed reader 1422 may receive one or more web feeds, convert said feeds into a format for presentation to a user, and render such presentation for the user. The web feeds may comprise or be associated with a blog, podcast, vlog, web site, and so on. In embodiments, the web feeds may be embodied as RSS, Atom, OPML, RDF/XML, XML, any and all combinations of the foregoing, and so on. In embodiments, the feed reader 1422 may encompass a standalone software application, an embedded software application, a software module that operates within another software application, a web application, and so on. Numerous feed reader clients are known in the art and may be suitable adapted to the methods and systems described herein.

The SMS client 1524 may comprise, be incorporated with, or otherwise be associated with a computing facility for receiving text messages in the SMS format. In embodiments, the SMS client 1524 may additionally or alternatively accept messages in the MMS format or any and all other messaging format. In embodiments, a cell phone or other portable communications device may comprise the SMS client 1524. The SMS client 1524 may communicate SMS, MMS, or other messages with the application server 1418. Numerous SMS clients are known in the art and may be suitable adapted to the methods and systems described herein.

The instant messenger 1428 may comprise Yahoo! Messenger, AOL Instant Messenger, Google Chat, or any and all other instant messaging applications, modules, software, and the like. The instant messenger 1428 may communicate text messages, audio messages or streams, video messages or streams, any and all combinations of the foregoing, and the like with the application server 1418. Numerous instant messenger clients are known in the art and may be suitable adapted to the methods and systems described herein.

The ambient device 1430 may comprise an automatic facility that receives information from the application 1418 and then displays a rendition or indication of the information for a user. The rendition or indication may be literal (such as and without limitation a numerical readout of numerical information) or metaphoric (such as and without limitation a color display that corresponds to numerical information). The ambient device 1430 may comprise a chipset for receiving and rendering information. In embodiments, the chipset may enable communications with a cell phone network, a wireless Internet network, a pager network, any and all combinations of the foregoing, or any and all other information networks. In embodiments, the ambient device 1430 may comprise an orb, a weather forecast/conditions display, a display that is associated with or embedded in a household appliance, or any other household, consumer, or other device that can incorporate a display or other human-perceptible signal.

The third party service 1440 may be any service or communication medium that might be usefully coupled to the client 1402. For example, this includes financial transaction services such as banks, credit card companies, online payment providers (e.g., PayPal), and so forth, any of which a client 1402 might securely access to provide or receive a payment. The third party service 1440 may be an online auction service such as eBay, where a user might post an item for auction, bid on an item for auction, or process a sale or purchase of an item through the auction. The third party service 1440 might include customer service for a business that provides customer support, technical support, sales, or the like. The third party service 1440 might include a communications service such as an e-mail server, an instant messaging server, a text messaging server, and so forth. Each third party service 1440 may independently maintain customer records, live support staff, and the like which can be accessed or deployed through the client 1402 using the system 1400.

It will be readily appreciated that enabling combinations of communications with several different types of third party services 1440 through a secure, non-public communications infrastructure provides opportunities for numerous value-added business-to-customer interactions supported by the client 1402 and system 1400. The client 1402 has a continuous presence similar to instant messaging so that a user can always receive instant notification of incoming messages when the client 1402 is connected to the gateway 1408. The client 1402 supports interactive communications in real time (using, e.g., the clock drift correction described above) or near real. The client 1402 is secure. The client 1402 supports authentication of users on both sides of a communication. The client 1402 operates with a non-public address so that only communications with pre-authorized (and authenticated) parties can occur. The client 1402 supports secure financial transactions, such as through the third-party services 1440 accessibly through the gateway 1408 and application server 1418. The client 1402 can similarly support secure interaction with websites, web services, web-accessible programming interfaces, and the like in order to conduct a variety of interactions between, e.g., a consumer and one or more businesses having a web presence.

Numerous uses of this secure, closed-circuit communications client are now described in greater detail, all of which can be deployed using the client 1402 and system 1400 described above. More generally, the systems and methods described herein may be employed, for example, to support a variety of secure, authenticated customer interactions ranging from technical support and customer service to tracking status and delivery of goods and services. Significantly, once the client 1402 has been installed on a user's computer and suitable credentials provided, the client 1402 can provides a convenient desktop-accessible link to a continuing relationship and interaction with one or more businesses.

The systems and methods may be usefully employed in customer support applications. In a customer support environment, a user may invite a business to communicate using the client 1402 (or the business may initiate a request for permission and contact information the client 1402). Customer support embodies any type of assistance made available to consumers, end users, customers, patrons, employees, students, individuals, groups, departments and companies by any organization, individual or entity that sells products, services and solutions. Customer support is often given by, but not limited to, software, hardware and device manufacturers and third party sales, service and solutions providers. In a customer support environment, a secure link may help ensure customer privacy, and permit a customer to provide personal or identification information to a trusted party. Still more conveniently, since the client 1402 is authenticated, it may not be necessary to provide additional information when contact is initiated with a business using the client 1402. This approach advantageously reduces personal information communicated over a network, since the business can rely on its own existing information relating to the (authenticated) user. Similarly, since the identity of the business is authenticated, a customer may confidently permit access to the client's local information, such as hardware or software configuration information that might be useful in a technical support environment. Additionally, a business can immediately alert a customer with service updates and other information, and can leverage these communications with any customer-related information at its disposal that is associated with the user/client that is receiving the communication.

A wide range of customer support services can be deployed using the client 1402 and system 1400 described herein including without limitation technical support, repair, problem resolution, IT support, IT department, live help. Web-based live help, Web-based support, customer care center, customer care service, contact center, mail-in service, carry-in service, depot service, service desk, diagnosis, replacement parts, replacement, customer-to-customer support, online communities, live support, live chat, real time support, on call support, help desk, on-site support, on-site technicians, off-site support, hotlines, online help, custom chat windows, face-to-face contact, self-service, self-help tools, bulletin board services, fax on demand, fax support, chat, applications, customer database, product monitoring, monitoring, alerts, product alerts, support professionals, service teams, support teams, SMS, interactive voice response, remote support, Internet sites, Internet site, support contracts, remote assistance software, remote assistance, support team, support representative, tasks, appointments, inbound calls, outbound calls, multi-channel support, online forms, training, live support applications, visitor monitoring, product monitoring, resolution, problem resolution, call resolution, service plans, support plans, repair plans, web-based training, on-site training, self-paced training, online training, departmental training, forums, forum, online forums, online community, online forum, online communities, support communities, phone centers, fee-based service, free service, premium service, extended service, product documentations, support documentation, written documentation, manuals, product bulletins, support websites, support centers, Internet sites, phone numbers, toll free phone service, paid phone service, instant messaging, instant messages, email support, emails, faxes, fax support, phone calls, phone support, databases, online documentation, internal tech support, volunteer support, peer support, immediate response, updates, recalls, product announcements, upgrades, exchange, refund, warranty support, troubleshooting, evaluation, dispatch of a technician, or any other active response to a customer problem.

The systems and methods described above may be usefully employed in online auctions. In this context, a secure link may be usefully employed between auction bidders, such as where a question or offer might be communicated, or between bidders and/or an auction host in order to conduct a financial transaction (or shipping or other transaction requiring personal information) resulting from a successful bid. The client 1402 may further integrate automated bidding services such as eSnipe or the like, permitting a user to configure an automated bid, monitor progress of an auction, and close a purchase of an auction item all within a single desktop widget or the like.

An auction is any type of sale in which property, sales or service is available to the highest bidder. Auctions may be by sealed or open bid. Many types of property, objects, items, licenses, services, companies, first hand goods, second hand goods, damaged goods, new goods, opportunities, experiences, commodities and entities may be sold at auction. Auctions depend upon a bid as a promise or contract of sale or offered price. Auctions may be live, phone in, catalogue-based, televised, broadcast, buy-out, absolute, Web-based, silent, mail in, public, private, exclusive, uniform-priced, second-priced, combinatorial, exchange, commodity, exchange-commodity, open outcry, all-bid, company sponsored, state sponsored, school, college or University sponsored, dealer sponsored, government sponsored, individually sponsored, charity sponsored, community sponsored, open or closed. Auctions may be for business, fund-raising, charity, education, profit, real estate purposes, clearance purposes, wholesale purposes, financial purposes, liquidation or inventory purposes, legal purposes, social purposes or entertainment. Auctions may be forced or voluntary. Auctioning is the process of buying or selling things according to open bid, and taking the highest bid as a sales contact or opportunity. Auctions can operate with reserve, without reserve, with our without a minimum price or bid. If bidding does not reach a reserve or begin at a minimum, a sale may or may not occur. An auction relies on opening a bid to a person or persons and determining the value of the object, property or service through bidding. Bidding may be one-time or incremental. An auction may determine the value of any particular entity, property or commodity. Internet auction sites or digital marketplaces such as Ebay, I-Offer, Yahoo! Auction, Amazon, uBid.com, inetbid.com are already well-known and commonly used, while specialized auctions such as LandAuction.com, policeauctions, bid4assets.com, PenBid, CNet Tech Auctions, AuctionWitch, and the like are also becoming more numerous.

The systems and methods described above may be usefully employed in online purchasing, such as for secure communications of related financial information. For example, a repeat customer of an online business may establish a communications circuit between the customer and a purchasing interface of the online business. Using this link, the customer may initiate a new purchase without re-entering payment and/or personal information. In one embodiment, financial information may be stored at the gateway 1408 or application server 1418, and provided to the online business when a customer initiates a purchase at the client 1402. In another embodiment, the online business may store information to complete a financial transaction, and the business may authenticate the purchaser/user with reference to the client 1402 without requiring that the user input additional information. Conversely, a user may authorize the online business to push promotions or other product information to the user's desktop through the client 1402. Thus in one aspect there is provided a method for incorporating permissions into a customer-to-business communication link through which a user specifies permission for various business-initiated communications.

The systems and methods described above may be usefully employed with newsfeeds, such as to provide security to commercial newsfeeds. A newsfeed is a collection of headlines or discussions that are published for distribution to the general public. A news feed is also known as a news aggregator, content distributor, news server, or news distributor. A news feed is a collection of headlines, news articles, information or discussions that is electronically distributed to multiple end users, search engines and web sites. A news feed offers constantly updated content distributed in data format. A news feed is syndicated, thereby allowing end users to subscribe at will or remove a feed from their aggregator. Types of content delivered by a news or data feed are webpage content, links to websites and links to digital media.

The systems and methods described above may be usefully employed with electronic mail (“email”), such as by providing an offer of a secure, real time communication link within an email. When the link is created, the system 1400 may simultaneously create and store an authorized user for communication with a corresponding client 1402. The link may be perpetual (until cancelled) or temporary. An electronic mail carrying the link may also include a link to a downloadable copy of the client 1402 so that a recipient can obtain suitable end-point software for a secure link. Invitations may be similarly transmitted to an SMS client, instant messaging client, or the like. In another aspect, the system 1400 may support an e-mail style communication interface. While individual messages may take the form of conventional e-mail, using the systems and methods described herein incoming and outbound electronic-mail-style messages are secured, and may only be transmitted among authorized, authenticated communicants. This approach may provide a spam-free, authenticated electronic mail communication channel between a business and a customer, or between any other entity or entities.

The systems and methods described above may be usefully employed in online advertising, such as by providing network users with a secure link to control preferences and permissions for advertising, including opt-in and opt-out choices based on content, sources, and so forth. The systems and methods described herein may also be usefully employed in tracking users for application service providers. User Tracking (also known as User Activity Tracking) is an ASP Application that enables an administrator to intelligently monitor end user activity. A web site administrator is able to track how many users are currently viewing a site, what IP address they are coming from, what browser they are using, and length of visitor sessions. The application may also be used to monitor detailed site interactions such as mouse movements and scrolling, input provided such as clicks, the amount of time spent per page, and navigation flow. On a more abstract level, User Tracking allows automatic and intuitive analysis of a web site, such as navigation patterns, PPC, SEO and ROI stats. It is useful for profiling users, extracting key information for marketing and commerce purposes. A user may authorize gathering of any such information by one or more authorized advertisers through the client 1402, or may authorize communications from certain advertisers through the client 1402 based on non-client 1402 based activities.

The systems and methods described herein may be usefully employed in web presentment. Web presentment as used herein refers to companies delivering bills and invoices electronically. Using the systems and methods described herein, an authenticated bill may be presented through a client 1402, and a user receiving the bill may provide a corresponding payment to the company through the client 1402 using the support of any user-selected third-party services 1440. In one aspect, the client 1402 may support presentment in a manner that allows one-click response using a “pay this bill” button or the like. The client 1402 may also integrate with other client-side software such as QuickBooks or MoneyWorks to create and enter a corresponding entry in a user's bookkeeping data. Individualized messaging may also be supported including associated advertisements, notes concerning payment history, and so forth.

The systems and methods described herein may be usefully employed in entertainment, such as for digital rights management or other limited or unlimited content distribution and rendering systems. Thus for example, the client 1402 may be used by music labels or other sources of copyrighted material to securely stream sample clips or the like, and the client 1402 may also or instead be used to affect payment for media. In general content that may be distributed digitally may include a video, a DVD, a CD, a radio broadcast, a video game, a computer game, a film, a book, or the like. While digital content purchase and distribution is one suitable application of the systems and methods described herein, it will be appreciated that the client 1402 and system 1400 may also be used for the purchase, rental, or loan of physical media such as books, videotapes, DVD's, and the like. The systems and methods described herein may also or instead be usefully employed for media delivery, such as for encryption key exchanges, purchases, and authentication for access, as well as for securing a delivery communication link for purchased or rented media.

The systems and methods described herein may be usefully employed for price tracking. For example, the client 1402 may be used to integrate price tracking data from numerous sources such as web sites, RSS sites, and proprietary sites that require a user login. All of the corresponding price data may be obtained and evaluated by the client 1402, or by the application server 1418 under control of the client 1402, and delivered in any desired manner to a user's desktop. In addition, specific alerts may be generated when certain price targets are met or exceeded within the price data obtained by the system. While consumer goods price tracking is one useful application, the system 1400 may also or instead be employed to track prices for utilities, services, real estate, contractor bids and so forth. The client 1402 may also automatically enter an order to purchase an item when a certain price trigger is reached, and may automatically initiate a financial transaction to pay for same.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and systems described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A system comprising:
a client interface supporting secure communications with a client;
an application server supporting secure communications with a third-party service; and
a gateway adapted to receive an authorization from the client for inbound messages from the third-party service, to provide real time notification to the client of an inbound message from the third-party service, and to create a substantially real time, secure, bi-directional communication link between the client and the third-party service upon acceptance of the inbound message by the client.

2. The system of claim 1 wherein the client is a desktop widget.

3. The system of claim 1 wherein the third-party service is one or more of a customer care service, a technical support service, or an advertisement service.

4. The system of claim 1 wherein the bi-directional communication link includes instant messaging.

5. The system of claim 1 wherein the gateway is further adapted to receive a message from the client and to responsively establish a client-initiated communication link, the client-initiated communication link including a substantially real time, secure, bi-directional communication link between the client and the third-party service.

6. The system of claim 5 wherein the client initiates a purchase transaction through the client-initiated link.

7. The system of claim 6 wherein the third-party service makes at least one recommendation for the purchase based on a profile associated with the client.

8 . A system comprising:
a client interface supporting secure communications with a client;
an application server supporting secure communications with a third-party service; and
a gateway adapted to automatically authenticate the client to the third-party service, and to establish a communications link between the client and the third-party service for conducting a transaction including payment by an online financial service, the link being a bi-directional, substantially real time, secure communications link.

9. The system of claim 8 wherein the client includes a desktop widget.

10. The system of claim 8 wherein the transaction includes a purchase of a digital content item.

11. The system of claim 10 wherein the digital content item is delivered to a user through the client.

12. The system of claim 10 wherein payment for the digital content item is provided through the online financial service.

13. A system comprising:
a client interface supporting secure communications with a client;
an application server supporting a first secure interface with an online auction system and a second secure interface with an online financial system; and
a gateway adapted to store first login credentials from the client for the online auction system and establish a secure link to the online auction system through the application server using the first login credentials, and to store second login credentials from the client for the online financial system and establish a secure link to the online financial system using the second login credentials, wherein the gateway transmits a status of an auction of an item in the online auction system to the client and wherein the gateway supports secure bidding for and purchase of the item from the client.

14. The system of claim 13 wherein the client includes a desktop widget.

15. The system of claim 13 wherein the gateway is adapted to store the first login credentials or the second login credentials at a remote location.

16. The system of claim 15 wherein the gateway is adapted to store the first login credentials or the second login credentials in encrypted form.

17. The system of claim 13 wherein the gateway is further adapted to store third login credentials from the client for an automated bidding system and establish a secure link to the automated bidding system using the third login credentials.

18. The system of claim 13 wherein the gateway transmits a real time status of the auction to the client, the real time status continually updated at the client.

19. The system of claim 13 wherein the gateway is adapted to receive a client authorization to receive unsolicited alerts from the online auction system.

20. The system of claim 13 wherein the online financial system includes a credit card system or a PayPal system.
